(19) United States
(12) Patent Application Publication
(10) Pub. No.: US 2009/0086254 A1
(43) Pub. Date: Apr. 2, 2009

(54) Systems and Methods for Dynamic Printer Configuration

(76) Inventor: Mike Hy Duong, Boulder, CO (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/864,782

(22) Filed: Sep. 28, 2007

(51) Int. Cl. G06F 3/12

(52) U.S. Cl. 358/1.15

(57) ABSTRACT

Systems and methods are provided for dynamically altering printer configurations during the processing of a print job based on analysis of rasterized bitmap data for at least one page face derived from print job data. In some embodiments, if analysis of rasterized bitmap data indicates that the reverse face of a page contains no data when the printer is printing in duplex mode, then the configuration of the printer may be set to single-sided so that the duplex unit on the printer can be bypassed. If both faces contain image data then the printer is set to duplex mode.

### TECHNICAL FIELD

This disclosure relates to the configuration of printing devices and, in particular, to systems and methods for dynamically altering printing modes based on information available in a bitmap representation of an image.

### DESCRIPTION OF RELATED ART

Typically, print jobs contain both data to be printed, and instructions for printing the data. These instructions may include information to configure the printer prior to the start of the job. The configuration established for the print job remains active for the duration of the job.

For example, conventional printers may print data in single-sided and/or duplex mode. Data printed in single sided mode can be printed on the obverse face of a page while data printed in duplex mode may be printed on both (the obverse and reverse) faces of a page. Duplex mode printing may use a duplex feeder, which runs the page through a duplex paper path. Once both faces of the page have been printed the page is ejected from the printer. While the use duplex print saves paper, it increases the time needed for a print job and increases wear on the printer.

Typically, print jobs are treated as single-sided or duplex in their entirety. Thus, every page in a duplex mode print job is run through the duplex unit even if one face is blank. Besides being inefficient, the unnecessary use of the duplex unit lengthens the time taken for a print job. Moreover, situations where users are being charged for each page face printed the use of duplex mode may cause users to be charged for an additional page face even when one side of a printed sheet is blank. This problem arises in part because the single-sided or duplex configuration of a printer is set prior to the start of a job and persists for the entire job. Therefore, a method and system that allows the configuration of the printer to be dynamically altered during the processing of a print job while ensuring the accuracy of printed page counts is desired.

### SUMMARY

In some methods for dynamically altering printer configuration the value of at least one parameter in a proposed configuration of the printer may be determined based on the analysis of the bitmap data for the at least one page face of a sheet; a current configuration of the printer may be updated by altering a value of at least one corresponding parameter in a current configuration to the value of the at least one parameter in the proposed configuration; and the updated configuration may be applied to print the at least one page face of the sheet according to the bitmap data.

Embodiments of the present invention also relate to software, firmware, and program instructions created, stored, accessed, or modified by processors using computer-readable media or computer-readable memory. The methods described may be performed on a computer and/or a printing device.

Additional objects and advantages will be set forth in part in the description, which follows, and in part will be obvious from the description, or may be learned by practice. The objects and advantages will be realized and attained by means of the elements and combinations particularly pointed out in the appended claims. It is to be understood that both the foregoing general description and the following detailed description are exemplary and explanatory only and are not restrictive of the invention, as claimed. These and other embodiments are further explained below with respect to the following figures.

### BRIEF DESCRIPTION OF THE DRAWINGS

FIG. 1 shows an exemplary system illustrating components for printing documents.

FIG. 2 shows a block diagram of an exemplary printer.

FIG. 3 shows pages generated by an exemplary print job.

FIG. 4 shows a flowchart illustrating steps in an exemplary method for printer configuration and management.

FIG. 5 illustrates interaction between functional modules in an exemplary system for printer configuration and management.

### DETAILED DESCRIPTION

Reference will now be made in detail to various embodiments, which are illustrated in the accompanying drawings. Wherever possible, the same reference numbers will be used throughout the drawings to refer to the same or like parts.

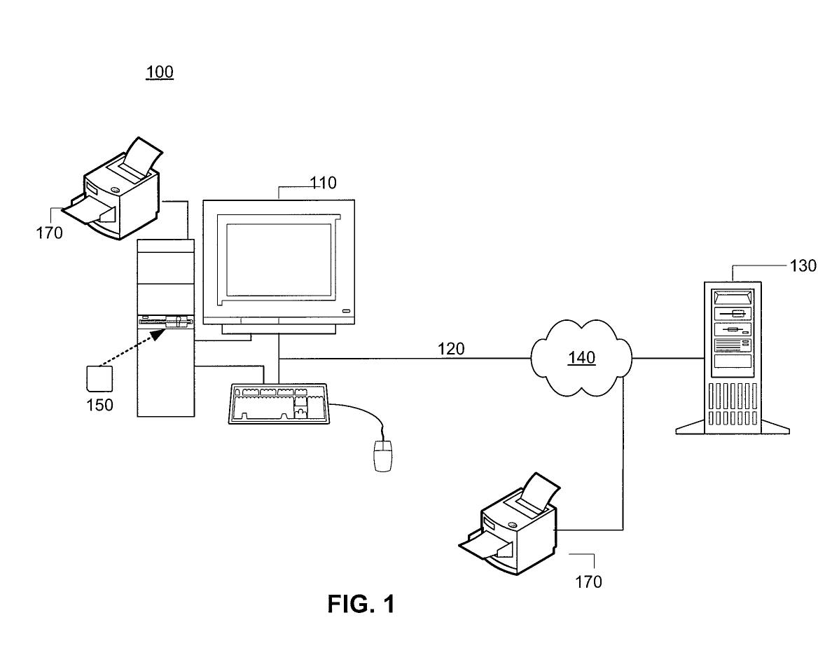

FIG. 1 shows a block diagram 100 illustrating components in an exemplary system for printing documents. As shown in FIG. 1, an application for dynamic configuration and management of printers may be deployed on a network of computers and printing devices that are connected through communication links, which allow information to be exchanged using conventional communication protocols and/or data port interfaces.

As shown in FIG. 1, exemplary system 100 includes computers such as exemplary computing device 110 and server 130. Further, computing device 110 and server 130 may communicate over a connection 120, which may pass through network 140. Computing device 110 may be a computer workstation, desktop computer, laptop computer, or any other computing device capable of being used in a networked environment. Server 130 may be a platform capable of connecting to computing device 110 and other devices (not shown). Computing device 110 and server 130 may be capable of executing software (not shown) that allows the printing of documents using printers 170.

Document processing software running on computing device 110 and/or server 130 may allow users to view, edit, process, and store documents conveniently. Pages to print in a document may be described in a page description language (“PDL”). PDL's may include PostScript, Adobe PDF, HP PCL, Microsoft XPS, and variants thereof. A PDL description of a document provides a high-level description of each page in a document. This PDL description is often translated to a series of lower-level printer-specific commands when the document is being printed.

The translation process from PDL to lower-level printer-specific commands may be complex and depend on the features and capabilities offered by exemplary printer 170. For example, printer 170 may process its data in stages. In a first stage, printer 170 may parse PDL commands and break down high-level instructions into a set of lower level instructions called primitives. These primitives may be fed to a subsequent stage in exemplary printer 170, which may use them to determine where to place marks on a page. In some instances, each primitive may be processed as it is generated. In other systems, a large set of primitives may be generated, stored, and then processed. For example, the primitives needed to describe a single page may be generated, stored in a list, and then processed. A set of stored primitives is often termed a display list.

Exemplary printer 170 includes devices that produce physical documents from electronic data including, but not limited to, laser printers, ink-jet printers, LED printers, plotters, facsimile machines, and digital copiers. The methods and apparatus described in this document may also be applied to these various device types of printer 170 with appropriate modifications and in a manner consistent with embodiments disclosed herein. Exemplary printer 170 may be capable of printing in single-sided mode, double-sided or duplex mode, black and white, and/or color mode. In single-sided mode, only one side of a print medium is printed, whereas in duplex mode both sides may hold printed images. In some embodiments, the printed image may be derived from a bitmapped image in a frame buffer. Exemplary printer 170 may also be capable of directly printing documents received from computing device 110 or server 130 over connection 120. In some embodiments such an arrangement may allow for the direct printing of documents, with (or without) additional processing by computing device 110 or server 130. The processing of documents, which may contain one or more of text, graphics, and images, can be distributed. Thus, computing device 110, server 130, and/or the printer may perform portions of document print processing such as half-toning, color matching, and/or other manipulation processes before a document is physically printed by printer 170.

Computing device 110 also contains removable media drive 150. Removable media drive 150 may include, for example, 3.5 inch floppy drives, CD-ROM drives, DVD ROM drives, CD±RW or DVD±RW drives, USB flash drives, and/or any other removable media drives. Portions of applications may reside on removable media and be read by computing device 110 using removable media drive 150 prior to being acted upon by system 100.

Connection 120 couples computing device 110, server 130, and printer 170 and may be implemented as a wired or wireless connection using conventional communication protocols and/or data port interfaces. In general, connection 120 can be any communication channel that allows transmission of data between the devices. In one embodiment, for example, the devices may be provided with conventional data ports, such as parallel ports, serial ports, Ethernet, USB, SCSI, FIREWIRE, and/or coaxial cable ports for transmission of data through the appropriate connection.

Network 140 could include a Local Area Network (LAN), a Wide Area Network (WAN), or the Internet. In some embodiments, information sent over network 140 may be encrypted to ensure the security of the data being transmitted. Printer 170 may be coupled to network 140 through connection 120. Exemplary printer 170 may also be connected directly to computing device 110 and/or server 130. System 100 may also include other peripheral devices (not shown). An application for flexible configuration and management for print devices may be deployed on one or more of the exemplary computers or printers, as shown in FIG. 1. For example, computing device 110 could download software directly from server 130, and portions of the application may be executed by exemplary printer 170. In some embodiments, an application for dynamic printer configuration and management may be executed entirely by printer 170 using some combination of hardware, software, and firmware.

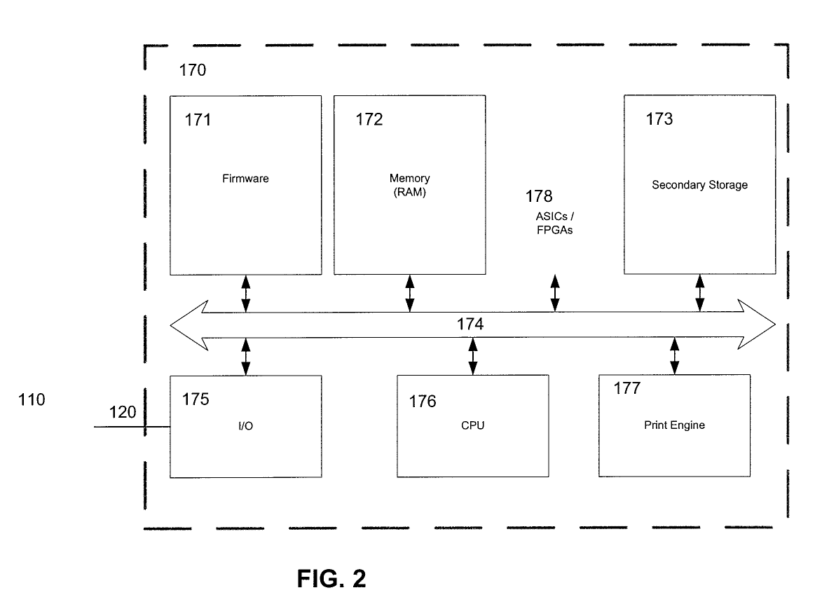

FIG. 2 shows a block diagram 200 of exemplary printer 170. Exemplary printer 170 may contain bus 174 that couples CPU 176, firmware 171, memory 172, input-output ports 175, print engine 177, and secondary storage device 173. Exemplary Printer 170 may also contain other Application Specific Integrated Circuits (ASICs), and/or Field Programmable Gate Arrays (FPGAs) 178 that are capable of executing portions of an application to print or process documents. Exemplary printer 170 may also be able to access secondary storage or other memory in computing device 110 using I/O ports 175 and connection 120. In some embodiments, printer 170 may also be capable of executing software including a printer operating system and other appropriate application software. Exemplary printer 170 may allow paper sizes, output trays, color selections, print modes such as single-sided and duplex mode, and print resolution, among other options, to be user-configurable.

Exemplary CPU 176 may be a general-purpose processor, a special purpose processor, or an embedded processor. CPU 176 can exchange data including control information and instructions with memory 172 and/or firmware 171. Memory 172 may be any type of Dynamic Random Access Memory (“DRAM”) such as but not limited to SDRAM, or RDRAM. Firmware 171 may hold instructions and data including but not limited to a boot-up sequence, pre-defined routines including routines for image processing, routines for dynamic printer configuration and management, trapping, document processing, and other code. In some embodiments, code and data in firmware 171 may be copied to memory 172 prior to being acted upon by CPU 176. Routines in firmware 171 may include code to translate page descriptions received from computing device 110 to display lists. In some embodiments, firmware 171 may include rasterization routines to convert display commands in a display list to an appropriate rasterized bitmap and store the bitmap in memory 172. Firmware 171 may also include routines to analyze and process bitmaps stored in memory such as a frame buffer, routines for image compression and decompression, and/or memory management routines. Data and instructions in firmware 171 may be upgradeable using one or more of computer 110, network 140, removable media coupled to printer 170, and/or secondary storage 173.

Exemplary CPU 176 may act upon instructions and data and provide control and data to ASICs/FPGAs 178 and print engine 177 to generate printed documents. ASICs/FPGAs 178 may also provide control and data to print engine 177. FPGAs/ASICs 178 may also implement one or more of translation, trapping, bitmap analyzing and processing, compression, and rasterization algorithms.

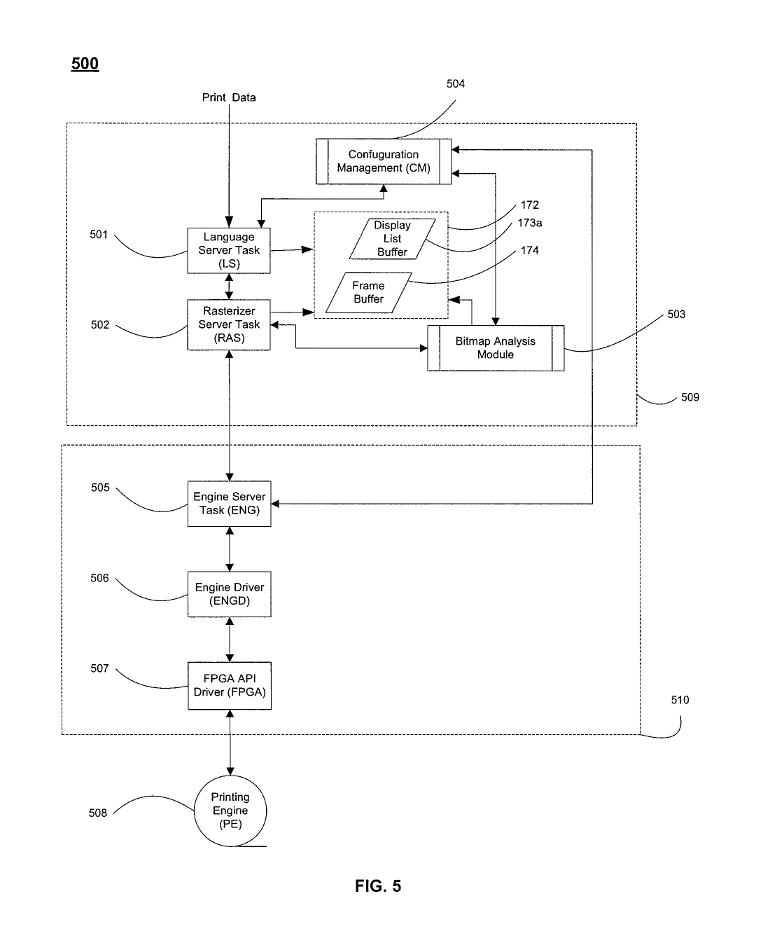

Exemplary computing device 110 may transform document data into a first printable data. In one embodiment, the first printable data may correspond to a PDL description of a document. Then, the first printable data can be sent to printer 170 for transformation into intermediate printable data. In some embodiments, the translation process from a PDL description of a document to the final printable data comprising of a series of lower-level printer-specific commands may include the generation of intermediate printable data comprising of display lists of objects. Display lists may hold one or more of text, graphics, and image data objects and one or more types of data objects in a display list may correspond to an object in a user document. Display lists, which may aid in the generation of intermediate printable data, may be stored in memory 172 or secondary storage 173. In one embodiment, a display list may be stored in display list buffer 520 (FIG. 5), which may be an area of memory.

Exemplary secondary storage 173 may be an internal or external hard disk, memory stick, or any other memory storage device capable of being used by system 200. In some embodiments, the display list may reside and be transferred between one or more of printer 170, computing device 110, and server 130 depending on where the document processing occurs. Memory to store display lists may be a dedicated memory or form part of general purpose memory, or some combination thereof. In some embodiments, memory to hold display lists may be dynamically allocated, managed, and released as needed. Printer 170 may transform intermediate printable data into a final form of printable data and print according to this final form.

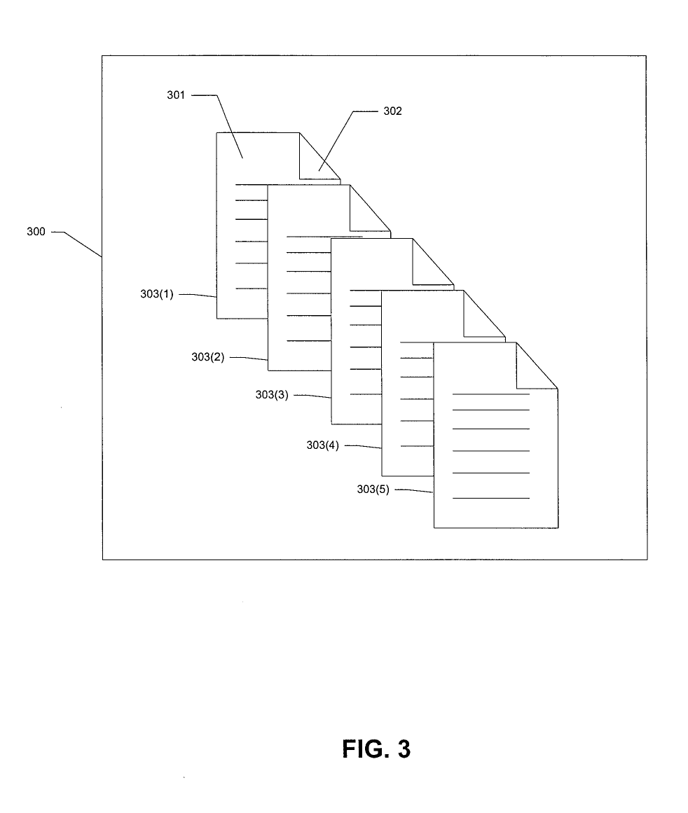

FIG. 3 shows print media or printed sheets 303 or simply printed pages generated by an exemplary print job 300. Print job 300 may comprise of a number of sheets to be printed, for example, five pages 303(1) through 303(5) are shown in FIG. 3. Sheet 303 may be printed according to print data received by printer 170. Each printed sheet 303 has two faces denoted by obverse page face 301 and reverse page face 302. As shown in FIG. 3, the obverse page face of sheet 303(1) is denoted by 301(1) and the reverse page face of sheet 303(1) by 302(1). In single-sided printing mode, the obverse page face 301 may be printed on by printer 170, while reverse page face 302 may be blank. In duplex printing mode, both page faces 301 and 302 may be printed on by printer 170. In duplex mode, both page faces of a printed sheet will have printed image data such as text, graphics, and/or images. However, if there is no data to print for a page face then that page face may be blank.

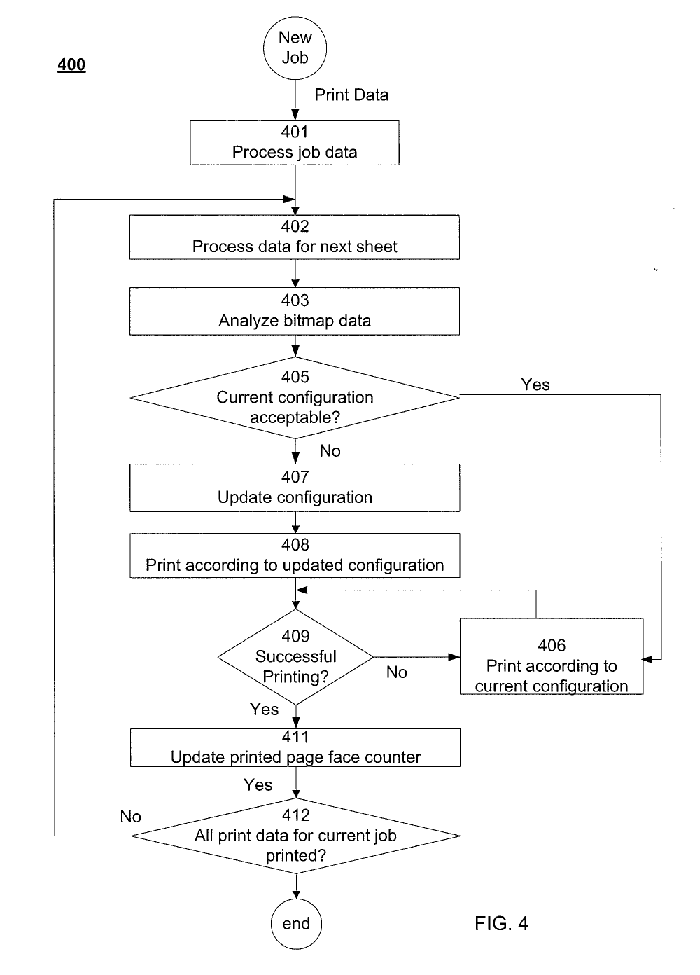

FIG. 4 shows a flowchart 400 illustrating steps in an exemplary method for printer configuration and management. The algorithm described in FIG. 4 may also be applied to copiers, multi-function devices and various other types of printing devices with appropriate modifications specific to the device and in a manner consistent with embodiments disclosed herein. In step 401, new print job data may be processed by according to information in one or more environment variables specified in print job 300. Such information may include the desired resolution of printed page frames, number of copies to be printed, print modes such as color, black and white, single-sided, or duplex.

In step 402, print data corresponding to an image for a new sheet 303 may be rasterized into bitmap data. Rasterization is the process by which information contained in a PDL or display list representation is transformed into a bitmap representation of an image. In a bitmap representation of an image also called a bitmapped image, frame buffer 530 can contain information related to how pixels will be printed by printer 170 on a print medium such as sheet 303. Rasterized bitmap data may be stored in frame buffer 530, which may reside in secondary storage 173, or memory (RAM) 172. In some embodiments, the processing of new print data may also include rasterizing print data into one or more bitmaps.

In some embodiments, bitmap data may be generated in bands that correspond to horizontal rectangular sections of exemplary printed sheet 303, respectively. Accordingly, a page may be divided logically in frame buffer 530 into multiple bands. Exemplary printer 170 may print images on sheet 303 one band at a time. In some embodiments, an entire page may be stored in frame buffer 530 prior to being printed on sheet 303. In general, the implementation of rasterization may depend on the specific capabilites offered by exemplary printer 170. Further, in step 403 of the exemplary flowchart, bitmap data may be analyzed to detect image features that are relevant to printer configuration, print accounting, and/or printer monitoring.

In some embodiments, bitmap data may be analyzed band-by-band. In some embodiments, analysis of bitmap data may occur after an entire band or page has been rendered. In one embodiment, the analysis of bitmap data may occur concurrently with the rendering of bitmap data into frame buffer. In another embodiment, bitmap analysis module 503 (FIG. 5) may detect when there is no data to be rendered for page 303. For example, if there is no data in frame buffer 530 to be printed on page face 301 and/or 302 of page 303, then bitmap analysis module 503 may send or set a blank page face indicator. In another embodiment, bitmap data in frame buffer may be analyzed to detect the percentage of sheet 303 that is covered by the image. In one embodiment, bitmap data may be analyzed to determine if the data for page face 301 or 302 is composed entirely of black and white pixels.

In some embodiments, the results obtained from analyzing bitmap data may be used to generate a proposed configuration of printer 170. The proposed configuration may comprise of proposed values that may be assigned to one or more printer configuration parameters. In some embodiments, these parameters may correspond to one or more printer configuration settings. For example, a parameter may correspond to a print mode setting that indicates whether the printer will print in single-sided or duplex mode.

In step 403, the values of parameters in the proposed configuration may be compared with corresponding parameter values in the current configuration of printer 170. In some embodiments, if the proposed configuration matches the current configuration (i.e. all proposed parameter values agree with their corresponding current parameter values) then the current configuration of printer 170 can be left unchanged. For example, the current configuration of the printer can be expressed as C=(C₁, C₂, C₃, . . . , Cₙ), where Cᵢ is the value of parameter i in the current configuration and n is the total number of parameters in the configuration of printer 170. Similarly, the proposed configuration can be denoted by P=(P₁, P₂, P₃, . . . , Pₙ), where proposed configuration parameter Pᵢ corresponds to current configuration parameter Cᵢ and vice versa. If Cᵢ=Pᵢ, for i=1 through i=n, (corresponding current and proposed configuration parameters match) then the proposed configuration of printer 170 is the same as the current configuration of printer 170 and no changes to the configuration are needed. Printing of the page may then be carried out using the current configuration of printer 170 in step 404.

If the current configuration of printer 170 differs from the proposed configuration, then the configuration settings of printer 170 may be updated in step 405 using the proposed configuration. The current configuration of printer 170 differs from the proposed configuration, if Cᵢ≠Pᵢ, for any i, in i=1 through i=n (one or more corresponding current and proposed configuration parameters differ).

For example, if an analysis of bitmap data in frame buffer 530 (in step 402) indicates that reverse page face 302 for sheet 303(3) is blank then a proposed print configuration setting for the print mode of printer 170 may be set to “single-sided,” prior to the physical printing of page 303(3) by printer 170. In this example, if the current print mode is “duplex,” then the algorithm will indicate (in step 403) that the current configuration differs from the proposed configuration. Accordingly, in step 405, the print mode configuration of printer 170 will be updated to single-sided so that only obverse page face 301 is printed and sheet 303 is not run through the duplex unit. In some embodiments, parameter values that have changed in the proposed configuration may be updated. In step 406, sheet 303 may be printed according to the updated configuration of printer. In some embodiments, the configuration of printer 170 for print job 300 may be updated or altered dynamically while print job 300 is being processed by printer 170. Dynamic alteration of the configuration of printer 170 allows changes to the configuration of printer 170 to be made during the processing of print job 300.

In some embodiments, in step 411, a page face counter may also be updated to indicate that only one side of sheet 303 contains a printed image. In one embodiment, an accounting module or a page face counter in printer 170 may add one to the page face count when a sheet exits the single-sided unit, and two to the page face count when the sheet 303 exits the duplex unit. In such embodiments, since the configuration of printer 170 has been updated to single-sided, the duplex unit will not be used for sheet 303 with a blank reverse page face 302 and the correct page face count will be maintained. In general, a page accounting module in a printer 170 may update or adjust page face counts appropriately to ensure accuracy of page face counts based on the type of mechanism used to maintain page face counts in printer 170.

As another example, if the next sheet 303(4) in current job 300 has image data on both sides and the current configuration of printer 170 is single-sided then the configuration of printer 170 may be updated to duplex prior to printing the sheet 303(4). In step 408, sheet 303 may be printed according to the updated configuration of printer and appropriate adjustments may be made to printer 170. Further, if both obverse page face 301 and reverse page face 302 are blank, a user may typically be charged for at least one face to cover the cost of paper and use of print resources. If it is desired that users should not be charged for blank pages then the algorithm may be easily modified to detect all blank page faces and only update a page face counter when non-blank faces are printed.

In step 409, the status of printing a page face (301 or 302) of sheet 303 is determined. If the page face has been successfully printed, then a page face counter may be updated. If the page face did not print successfully, then the page may reprinted using the current stored configuration. In step 412, if print job 300 has completed then the algorithm terminates for current print job 300 and printer 170 waits for a new print job. If print job 300 has not ended the algorithm returns to step 402.

FIG. 5 illustrates interaction between functional modules in an exemplary system for printer configuration and management. The functional modules shown in FIG. 5 are exemplary and for descriptive purposes only and a different combination of modules, and/or modules with different functionality from those shown, may be used to implement the described tasks.

As shown in FIG. 5, print data may be transmitted to language server task 501. Exemplary language server task 501 may read print data, parse PDL commands, and generate display list primitives. In some embodiments, environment variables specified in print job 300 may be used to configure printer 170 using exemplary configuration management module 504. Accordingly, environment variables present in print job 300, or generated by language server 501, from print data may be used to set, update, or reset parameter values affecting the configuration of printer 170. Such information may include the desired resolution of printed page frames, number of copies to be printed, print modes such as color, black and white, single-sided, or duplex and other configuration options for printer 170. Language server 501 may both read data from and write to configuration settings on printer 170 using exemplary configuration management module 504. Configuration management module 504 may set the configuration of printer 170 for print job 300 and facilitate the communication of configuration settings to other modules of printer 170.

In some embodiments, display list primitives generated by language server 501 may be stored in a display list buffer 520, which may reside in memory 172, and/or secondary storage 173 at various points in time during the processing of print job 300. Exemplary rasterizer server task 502 may rasterize data in display list buffer 520 into bitmap data that may be stored in frame buffer 530. In some embodiments, rasterizer server task 502 may communicate with engine server task 505 to schedule primitives for rasterizing. In one embodiment, rasterizer server module 502 may also send bitmap data to engine server task 505. In another embodiment, exemplary rasterizer server module 502 may provide pointers or addresses to the start of bitmap data and/or to other locations in bitmap data, to other modules.

In some embodiments, bitmap analysis module 503 may analyze bitmap data using pointers or addresses provided. For example, bitmap analysis module 503 could include routines for a blank page face detector, which may analyze bitmap data to determine whether reverse page face 302 of a sheet 303 is blank. Based on this determination configuration of printer 170 may be dynamically updated. For example, bitmap analysis module 503 may interact with configuration management module 504 to dynamically change the configuration settings of printer 170 to single-sided when it detects that reverse page face 302 of sheet 303 does not have a printed image. On the other hand, if printer 170 is in a single-sided print mode and both sides of sheet 303 are determined to contain printed images, then the configuration of printer 170 may be dynamically changed to duplex mode.

Engine server module 505 may schedule primitives for rasterizing by rasterizer server task 502. Engine server module 505 may also inform engine driver module 506 of the sequence in which bitmap data may be processed and may communicate with engine driver module 506 to monitor the status of print engine 177. In some embodiments, engine server module 505 may utilize resources provided by FPGAs and/or ASICs 178, through FPGA/ASIC driver(s) 507 to accomplish one or more of its functions. Exemplary engine server module 505 may monitor printer events such as paper jams, printer malfunctions, etc. and may determine if sheet 303 has been successfully printed. In some embodiments, engine server module 505 may obtain printer configuration information from configuration management module 504. Exemplary print engine may then print bitmap data onto images on obverse page face 301 and/or reverse page face 302 of sheet 303.

In some embodiments, exemplary language server module 501, rasterizer server module 502, bitmap analysis module 503, engine server module 505, and engine driver module 506 may communicate with each other asynchronously and exchange command, data, and/or status information. Thus, information may be shared among these components at any time during the processing of print data for print job 300. For example, while engine driver module 506 instructs print engine 177 to feed sheet 303 from a designated input tray of printer 170 for printing: engine server module 177 may be concurrently communicating with rasterizer server module 502 to schedule a subsequent page face for rendering; rasterizer server task 502 may be rasterizing a page; and bitmap analysis module 503 may be analyzing one or more bitmaps.

In some embodiments, exemplary system 500 may be viewed as comprising of a product code layer 509 and a product specific engine code layer 510 as shown by the dotted lines in FIG. 5. It should be noted that the division of functional modules between the two layers is exemplary and for descriptive purposes only and other implementations are possible and would be known to one of reasonable skill in the art. For example, product code layer 509 may be responsible for implementing one or more functions relating to the conversion of print data received from computer 110 into bitmap data, while product specific engine code layer 510 may be responsible for operating on bitmapped image data in frame buffer 530 and communicating the bitmapped image data to print engine 177 for final printing on sheet 303. In some embodiments, product specific engine code 510 may also monitor printing instructions and/or printer status. In one implementation, a bitmap analysis module may be added to an existing printer by modifications to the product code layer 509.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for dynamically altering printer configuration, the method comprising:
analyzing bitmap data for at least one page face of a sheet;
determining the value of at least one parameter in a proposed configuration of the printer based on the analysis of the bitmap data for the at least one page face;
updating a current configuration of the printer by altering a value of at least one corresponding parameter in a current configuration to the value of the at least one parameter in the proposed configuration; and
applying the updated configuration to print the at least one page face of the sheet according to the bitmap data.

2. The method of claim 1, wherein analyzing the bitmap data for the at least one page face further comprises analyzing bitmap data for at least one reverse page face.

3. The method of claim 1, wherein the analysis of the bitmap data for the at least one page face further comprises determining if the bitmap data for the page face contains substantive bitmapped image data.

4. The method of claim 1, wherein the value of the corresponding parameter in the current configuration is altered to the value of the parameter in the proposed configuration when the value of the parameter in the proposed configuration differs from the value of the corresponding parameter in the current configuration.

5. The method of claim 1, wherein determining the value of at least one parameter in the proposed configuration of the printer based on the analysis of the bitmap data for the at least one page face further comprises:
setting the value of a proposed print-mode parameter of the printer to single-sided, if analysis of the bitmap data for a reverse page face indicates that the reverse page face is blank; and
setting the value of a proposed print-mode parameter of the printer to duplex otherwise.

6. The method of claim 1, wherein the bitmap data resides in a frame buffer.

7. The method of claim 5, wherein the reverse page face is blank when the bitmap for the reverse page face contains no substantive bitmapped data.

8. The method of claim 1, wherein the method is performed entirely on a printer.

9. A computer-readable memory that contains instructions, which when executed by a processor perform steps in a method for dynamically altering printer configuration, the method comprising:
analyzing bitmap data for at least one page face of a sheet;
determining the value of at least one parameter in a proposed configuration of the printer based on an analysis of the bitmap data for the at least one page face;
updating a current configuration of the printer by altering a value of at least one corresponding parameter in a current configuration to the value of the at least one parameter in the proposed configuration; and
applying the updated configuration to print the at least one page face of the sheet according to the bitmap data.

10. The computer-readable memory of claim 9, wherein analyzing the bitmap data for the at least one page face further comprises analyzing bitmap data for at least one reverse page face.

11. The computer-readable memory of claim 9, wherein analyzing the bitmap data for at least on page face further comprises determining if the bitmap data for the page face contains any substantive bitmapped image data.

12. The computer-readable memory of claim 9, wherein updating the current configuration of the printer with the value of the at least one parameter in the proposed configuration is performed when the value of the parameter in the proposed configuration differs from the value of the parameter in the current configuration.

13. The computer-readable memory of claim 9, wherein determining the value of at least one parameter in the proposed configuration of the printer based on the analysis of the bitmap data for the at least one page face further comprises:
setting the value of the proposed print-mode parameter of the printer to single-sided, if analysis of the bitmap data for a reverse page face indicates that the reverse page face is blank; and
setting the value of the proposed print-mode parameter of the printer to duplex otherwise.
